(19) United States
(12) Patent Application Publication
(10) Pub. No.: US 2014/0104524 A1
(43) Pub. Date: Apr. 17, 2014

(54) Display Panel and Display Apparatus Having the Same

(71) Applicant: SAMSUNG DISPLAY CO., LTD., YONGIN-CITY (KR)

(72) Inventors: CHANG-HUN LEE, HWASEONG-SI (KR); CHEOL SHIN, HWASEONG-SI (KR); KI-CHUL SHIN, SUWON-SI (KR); SEUNG-HO HONG, GUNPO-SI (KR)

(73) Assignee: SAMSUNG DISPLAY CO., LTD., YONGIN-CITY (KR)

(21) Appl. No.: 13/796,926

(22) Filed: Mar. 12, 2013

(30) Foreign Application Priority Data
Oct. 11, 2012 (KR) 10-2012-0112961

(51) Int. Cl. G09G 3/36

(52) U.S. Cl. CPC G09G 3/36
USPC 349/41

(57) ABSTRACT

A display panel includes an array substrate comprising a first substrate, a first electrode disposed on the first substrate, and a second electrode disposed on the first electrode, the second electrode insulated from the first electrode and having a slit pattern, an opposite substrate facing the array substrate and comprising a second substrate, and a third electrode disposed on the second substrate, a voltage applied to the third electrode being different from a voltage applied to the second electrode, and a liquid crystal layer disposed between the array substrate and the opposite substrate, and including reactive monomer.

This application claims priority to Korean Patent Application No. 10-2012-0112961, filed on Oct. 11, 2012 under 35 U.S.C. §119, the disclosure of which is incorporated by reference herein in its entirety.

### TECHNICAL FIELD

Example embodiments of the invention relate to a display panel and a display apparatus having the display panel.

### DISCUSSION OF THE RELATED ART

Liquid crystal display (LCD) panels include vertical electric field types, horizontal electric field types, and hybrid types.

Hybrid-type display panels have various alignment directions of liquid crystal molecules. Accordingly, the hybrid-type display panels include a phase-difference compensating film designed to have a different structure from that of other types of LCD panels. The conventional hybrid-type display panels have a relatively low response speed.

### SUMMARY

According to an exemplary embodiment of the invention, a display panel includes an array substrate comprising a first substrate, a first electrode disposed on the first substrate, and a second electrode disposed on the first electrode, the second electrode insulated from the first electrode and having a slit pattern, an opposite substrate facing the array substrate and comprising a second substrate, and a third electrode disposed on the second substrate, a voltage applied to the third electrode being different from a voltage applied to the second electrode, and a liquid crystal layer disposed between the array substrate and the opposite substrate, and including a reactive monomer.

In an exemplary embodiment of the present invention, a reference voltage may be applied to the third electrode. A voltage alternating with respect to the reference voltage may be applied to the second electrode.

In an exemplary embodiment of the present invention, the display panel may further include lower alignment layer disposed under the liquid crystal layer. The lower alignment layer may align liquid crystal directors in a lower portion of the liquid crystal layer along a horizontal direction of the display panel.

In an exemplary embodiment of the present invention, the lower alignment layer may have a rubbing axis inclined at 45 degrees with respect to a longitudinal direction of the slit pattern of the second electrode

In an exemplary embodiment of the present invention, the display panel may further include an upper alignment layer disposed on the liquid crystal. The upper alignment layer may align liquid crystal directors in an upper portion of the liquid crystal layer along a vertical direction of the display panel.

In an exemplary embodiment of the present invention, the voltage may alternate in a range of about +5 volts to about −5 volts with respect to the reference voltage.

In an exemplary embodiment of the present invention, the display panel may further include a phase-difference compensating film disposed on the opposite substrate, and compensating for a retardation (d^{Δ}n; d means cell gap, n means refractive index) of the liquid crystal layer.

In an exemplary embodiment of the present invention, a retardation of the phase-difference compensating film may be about 0.01 μm to about 0.8 μm.

In an exemplary embodiment of the present invention, the reactive monomer may include an acrylic photoreactive monomer.

In an exemplary embodiment of the present invention, concentration of the reactive monomer in the liquid crystal layer may be about 0.2 wt % to about 20 wt %.

According to an exemplary embodiment of the invention, a display apparatus includes a display panel displaying the image, a backlight assembly disposed under the display panel to supply light to the display panel, and a receiving container receiving the display panel and the backlight assembly. The display panel includes an array substrate comprising a first substrate, a first electrode disposed on the first substrate, and a second electrode disposed on the first electrode, the second electrode insulated from the first electrode and having a slit pattern, an opposite substrate facing the array substrate and comprising a second substrate, and a third electrode disposed on the second substrate, a voltage applied to the third electrode being different from a voltage applied to the second electrode, and a liquid crystal layer disposed between the array substrate and the opposite substrate, and including a reactive monomer.

In an exemplary embodiment of the present invention, a reference voltage may be applied to the third electrode. A voltage alternating with respect to the reference voltage may be applied to the second electrode.

In an exemplary embodiment of the present invention, the display panel may further include lower alignment layer disposed under the liquid crystal layer. The lower alignment layer may align liquid crystal directors in a lower portion of the liquid crystal layer along a horizontal direction of the display panel.

In an exemplary embodiment of the present invention, the lower alignment layer may have a rubbing axis inclined at 45 degrees with respect to a longitudinal direction of the slit pattern of the second electrode

In an exemplary embodiment of the present invention, the display panel may further include an upper alignment layer disposed on the liquid crystal. The upper alignment layer may align liquid crystal directors in an upper portion of the liquid crystal layer along a vertical direction of the display panel.

In an exemplary embodiment of the present invention, the voltage may alternate in a range of about +5 volts to about −5 volts with respect to the reference voltage.

In an exemplary embodiment of the present invention, the display apparatus may further include a phase-difference compensating film disposed on the opposite substrate, and compensating for a retardation (d^{Δ}n; d means a cell gap, and n means a refractive index) of the liquid crystal layer.

In an exemplary embodiment of the present invention, a retardation of the phase-difference compensating film may be about 0.01 μm to about 0.8 μm.

In an exemplary embodiment of the present invention, the reactive monomer may include an acrylic photoreactive monomer.

In an exemplary embodiment of the present invention, a concentration of the reactive monomer in the liquid crystal layer may be about 0.2 wt % to about 20 wt %.

According to an embodiment of the present invention, there is provided a display panel including a first substrate having a first electrode, a second substrate opposite to the first substrate, the second substrate having a second electrode, a third electrode, and a switching element connected to the third electrode, and a liquid crystal layer between the first substrate and the second substrate, wherein the first electrode is applied with a constant voltage, and the second electrode is applied with an alternating voltage.

### BRIEF DESCRIPTION OF THE DRAWINGS

The above and other features of the invention will become more apparent by describing in detail example embodiments thereof with reference to the accompanying drawings, in which:

FIG. 1 is a cross-sectional view illustrating a display panel according to an exemplary embodiment of the invention;

FIG. 2 is a plan view illustrating the second electrode of FIG. 1 corresponding to a pixel area to describe a rubbing-angle of the alignment layer of FIG. 1;

FIG. 3 is a graph illustrating maximum transmittance versus retardation (d^{Δ}n) for rubbing-angles;

FIG. 4 is a graph illustrating voltage versus cell gap;

FIG. 5A to 5D are graphs illustrating voltages applied to third, second and first electrodes and an effective voltage;

FIG. 6 is a graph illustrating transmittance versus voltage difference between a second electrode and a first second electrode of the display panel of FIG. 1 for rubbing-angles and voltage differences between a third electrode and the second electrode;

FIG. 7 is a graph illustrating maximum transmittance versus voltage difference between the third electrode and the second electrode of the display panel of FIG. 1 for rubbing-angles;

FIG. 8 is a cross-sectional view illustrating a display panel according to an exemplary embodiment of the invention;

FIG. 9 is a graph illustrating the retardation of a phase-difference compensating film transmittance versus voltage difference between the third electrode and the second electrode of the display panel of FIG. 1;

FIG. 10 is a cross-sectional view illustrating a display panel according to an exemplary embodiment of the invention; and

FIG. 11 is an exploded perspective view illustrating a display panel according to an exemplary embodiment of the invention.

### DETAILED DESCRIPTION OF EXAMPLE EMBODIMENTS

Hereinafter, embodiments of the invention will be described in detail with reference to the accompanying drawings. The same reference denotations may be used to refer to the same or substantially the same elements throughout the specification and the drawings.

The present invention may, however, be embodied in many different forms and should not be construed as being limited to the embodiments set forth herein. Like reference numerals may denote like or similar elements throughout the specification and the drawings.

It will be understood that when an element is referred to as being “on,” “connected to” or “coupled to” another element, it can be directly on, connected to or coupled to the other element or intervening elements may be present.

As used herein, the singular forms “a,” “an” and “the” are intended to include the plural forms as well, unless the context clearly indicates otherwise.

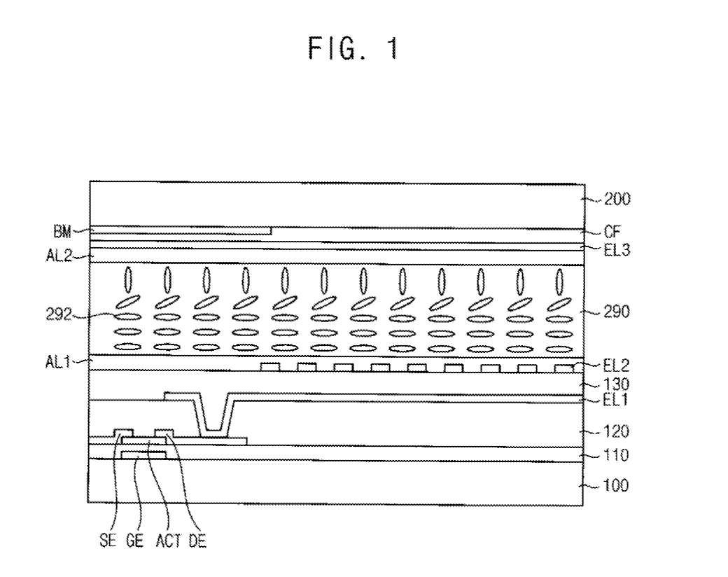

FIG. 1 is a cross-sectional view illustrating a display panel according to an exemplary embodiment of the invention.

Referring to FIG. 1, the display panel includes an array substrate, an opposite substrate, and a liquid crystal layer 290 disposed between the array substrate and the opposite substrate. The array substrate includes a first substrate 100, a gate electrode GE, a first insulation layer 110, an active layer ACT, a data electrode DE, a source electrode SE, a second insulation layer 120, a first electrode EL1, a third insulation layer 130, a second electrode EL2, and a lower alignment layer AL1. The opposite substrate includes a second substrate 200, a black matrix BM, a color filter CF, a third electrode EL3, and an upper alignment layer AL2. The first electrode EL1 may be, e.g., a pixel electrode, and the second electrode EL2 may be, e.g., a common electrode.

The first substrate 100 may be a transparent insulation substrate made of, e.g., glass and/or plastic. The first substrate 100 is divided into a plurality of pixel areas. Although only one pixel area is described in the figures, the display panel according to an exemplary embodiment may include a large number of pixel units respectively formed in pixel areas. The pixel areas are typically arrayed, for example, in a matrix structure having a plurality of rows and columns. The pixel areas have the same or substantially the same structure, and one pixel area is described herein as an example. However, the embodiments of the present invention are not limited thereto, and according to an embodiment of the present invention, a color filter portion may have a different color, and a pixel area may have a different size or shape. Although the pixel area has a rectangular shape in the figures, the pixel area may have various modifications in size and/or shape and/or number of field altering slits or other fine features included therein. For example, the pixel areas may have V or Z shapes.

The gate electrode GE is disposed on the first substrate 100, and electrically connected to a gate line. The gate electrode GE may includes may include copper (Cu) and copper oxide (CuOx). The gate electrode GE may include gallium doped zinc oxide (GZO), indium doped zinc oxide (GZO) and/or manganese-copper alloy (CuMn).

The first insulation layer 110 is disposed on the gate electrode GE and electrically insulates the gate electrode GE from other elements. The first insulation layer 110 may include silicon oxide (SiOx) and silicon nitride (SiNx).

The active layer ACT is disposed on the first insulation layer 110. The active layer ACT overlaps the gate electrode GE.

The active layer ACT may include a semiconductor layer including amorphous silicon (a-Si:H) and an ohmic contact layer including n+ amorphous silicon (n+ a-Si:H). The active layer ACT may include an oxide semiconductor. The oxide semiconductor may include an amorphous oxide including at least one of indium (In), zinc (Zn), gallium (Ga), tin (Sn) and hafnium (Hf). For example, the oxide semiconductor may include an amorphous oxide including indium (In), zinc (Zn) and gallium (Ga), or an amorphous oxide including indium (In), zinc (Zn) and hafnium (Hf). The oxide semiconductor may include an oxide, such as indium zinc oxide (InZnO), indium gallium oxide (InGaO), indium tin oxide (InSnO), zinc tin oxide (ZnSnO), gallium tin oxide (GaSnO) and gallium zinc oxide (GaZnO). For example, the active layer ACT may include indium gallium zinc oxide (IGZO).

The source electrode SE is disposed on the active layer ACT, and electrically connected to a data line that crosses the gate line. The source electrode SE partially overlaps the gate electrode GE. The source electrode SE may include copper (Cu) and copper oxide (CuOx). The source electrode SE may include gallium doped zinc oxide (GZO), indium doped zinc oxide (GZO) and/or manganese-copper alloy (CuMn).

The drain electrode DE is disposed on the active layer ACT. The drain electrode DE partially overlaps the gate electrode GE, and is spaced apart from the source electrode SE. The drain electrode DE may include copper (Cu) and copper oxide (CuOx). The drain electrode DE may include gallium doped zinc oxide (GZO), indium doped zinc oxide (GZO) and/or manganese-copper alloy (CuMn). Boundaries of the active layer ACT may coincide with boundaries of the source electrode SE and the drain electrode DE. The active layer ACT, the drain electrode DE, the gate electrode GE and the source electrode SE and the source electrode SE form a thin film transistor.

The second insulation layer 120 is disposed on the first insulation layer 110 on which the source electrode SE and the drain electrode DE are disposed. The second insulation layer 120 electrically insulates the source electrode SE, the active layer ACT and the drain electrode DE from other elements. The second insulation layer 120 may include silicon oxide (SiOx) and silicon nitride (SiNx).

The first electrode EL1 is disposed on the second insulation layer 120, and corresponds to a pixel area where an image is displayed. The first electrode EL1 is electrically connected to the drain electrode DE through a contact hole which is formed on the second insulation layer 120 and which partially exposes the drain electrode DE. The first electrode EL1 may include a transparent conductive material, such as indium tin oxide (ITO), or indium zinc oxide (IZO). The first electrode EL1 may include titanium (Ti) and/or molybdenum titanium (MoTi).

The third insulation layer 130 is disposed on the first electrode EL1. The third insulation layer 130 electrically insulates the first electrode EL1 from other elements. The third insulation layer 130 may include silicon oxide (SiOx) and silicon nitride (SiNx).

The second electrode EL2 is disposed on the third insulation layer 130, and corresponds to the pixel area. The second electrode EL2 has a slit pattern. Although the slit pattern extends along vertical direction of the pixel area in the figures, the slit pattern may have various modifications in size and/or shape and/or number of field altering slits or other fine features included therein. For example the slit pattern may have V or Z shapes.

The second electrode EL2 may include a transparent conductive material, such as indium tin oxide (ITO), or indium zinc oxide (IZO). The second electrode EL2 may include titanium (Ti) and/or molybdenum titanium (MoTi).

The first alignment layer AL1 is disposed on the second electrode EL2 and the third insulation layer 130. Liquid crystal directors 292 disposed in a lower portion of the liquid crystal layer 290 may be aligned in a horizontal direction by the first alignment layer AL1. For example, the first alignment layer AL1 may be rubbed to align liquid crystal molecules included in the lower portion of the liquid crystal layer 290 along the horizontal direction. The second substrate 200 may be a transparent insulation substrate made of, e.g., glass and/or plastic.

The black matrix BM is disposed under the second substrate 200. The black matrix BM corresponds to an area except for the pixel area, and blocks light. The black matrix BM overlaps the thin film transistor, the data line and the gate line. Although the black matrix BM overlaps the thin film transistor, the data line and the gate line in the present exemplary embodiment, the black matrix BM may be disposed in any area where light should be blocked.

The color filter CF is disposed under the black matrix BM and the second substrate 200. Light passing through the color filter CF from the liquid crystal layer 290 has a color. The color filter CF may include a red color filter, a green color filter or blue color filter. The color filter CF corresponds to a pixel area. Color filters adjacent to each other may have different colors, respectively. The color filter CF may overlap an adjacent color filter CF at a boundary of the pixel area, or the color filter CF may be spaced apart from the adjacent color filter CF at the boundary of the pixel area.

The third electrode EL3 is disposed under the color filter CF. The third electrode EL3 may include a transparent conductive material, such as indium tin oxide (ITO), or indium zinc oxide (IZO). The third electrode EL3 may include titanium (Ti) and/or molybdenum titanium (MoTi).

The second alignment layer AL2 is disposed under the third electrode EL3. Liquid crystal directors 292 disposed in an upper portion of the liquid crystal layer 290 may be aligned in a vertical direction by the second alignment layer AL2. For example, the second alignment layer AL2 need not have a rubbing axis to align liquid crystal molecules included in the upper portion of the liquid crystal layer 290 in the vertical direction.

The liquid crystal layer 290 is disposed between the array substrate and the opposite substrate. The liquid crystal layer 290 includes liquid crystal molecules having optical anisotropy. The liquid crystal molecules are driven by an electric field, and an image is displayed by passing or blocking light through the liquid crystal layer 290.

The liquid crystal directors 292 represent directions of the liquid crystal molecules. According to the rubbing axis of the first and second alignment layers AL1 and AL2 contacting the liquid crystal layer 290, directions of the liquid crystal directors 292 adjacent to the first and second alignment layers AL1 and AL2 may be determined.

The liquid crystal directors 292 in the lower portion of the liquid crystal layer 290 are substantially parallel with the first and second substrates 100 and 200. The liquid crystal directors 292 in the upper portion of the liquid crystal layer 290 are substantially perpendicular to the first and second substrates 100 and 200.

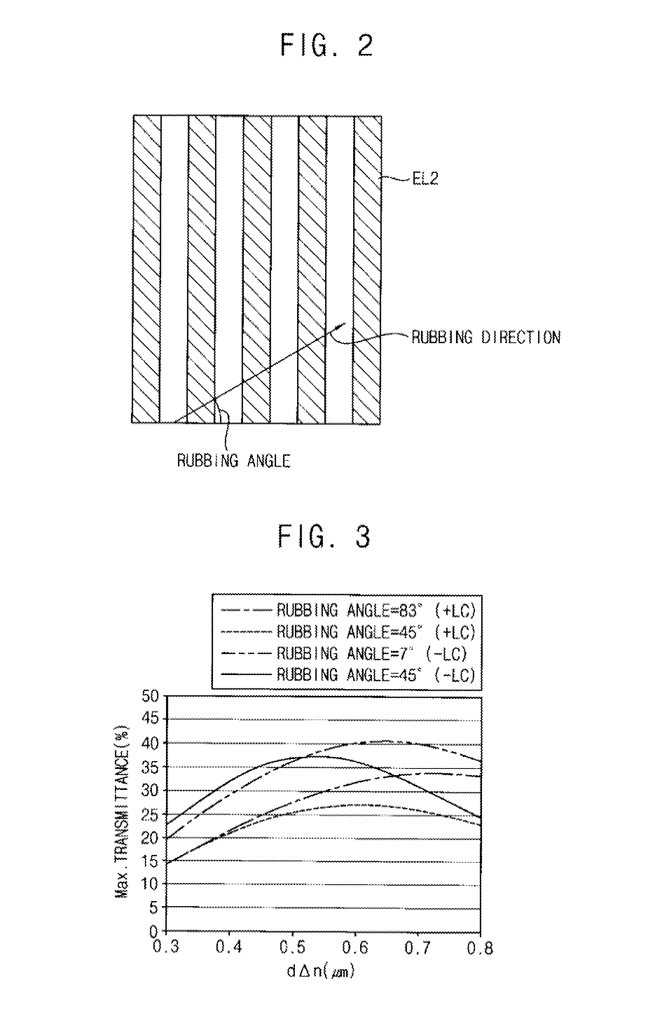

FIG. 2 is a plan view illustrating a second electrode of FIG. 1 corresponding to a pixel area to describe a rubbing-angle of an alignment layer of FIG. 1.

Referring to FIG. 2, a first alignment layer (e.g., the first alignment layer AL1 of FIG. 1) is rubbed while inclined with respect to a horizontal axis of a pixel area. A slit pattern of the second electrode EL2 extends along a vertical axis of the pixel area in an exemplary embodiment of the present invention, and a rubbing direction is thus inclined by a rubbing-angle with respect to a direction which is perpendicular to an extending direction of the slit pattern. Thus, the rubbing direction has the rubbing-angle with respect to the horizontal axis of the pixel area. The rubbing-angle may be adjusted according to an absolute value of a dielectric anisotropy of the liquid crystal to optimize a transmittance.

FIG. 3 is a graph illustrating maximum transmittance versus retardation (d^{Δ}n) for rubbing-angles.

Referring to FIG. 3, an x-axis represents retardations (d^{Δ}n, where d means a cell gap, and n means a refractive index), and a y-axis represents maximum transmittances. The cell gap d is a thickness of a liquid crystal layer (e.g., the liquid crystal layer 290 of FIG. 1), and the refractive index n is a refractive index of the liquid crystal layer. When a rubbing-angle (e.g., the rubbing-angle described above in connection with FIG. 2) of a first alignment layer (e.g., the first alignment layer AL1 of FIG. 1) according to an exemplary embodiment is 83 degrees and the liquid crystal layer includes positive liquid crystal (+LC), and when the rubbing-angle is 45 degrees and liquid crystal layer includes positive liquid crystal, the maximum transmittance versus the retardation (d^{Δ}n) graph is illustrated in FIG. 3.

In addition, when the rubbing-angle is 7 degrees, and negative liquid crystal is used in a conventional PLS mode display panel, and when the rubbing-angle is 45 degrees, and negative liquid crystal is used in a conventional PLS mode display panel, the maximum transmittance versus the retardation (d^{Δ}n) graph is illustrated in FIG. 3.

In an exemplary embodiment of the present invention, the positive liquid crystal has a dielectric constant Δ∈ of about +10. The negative liquid crystal has a dielectric constant Δ∈ of about −4.

As illustrated in FIG. 3, when the display panel is in the conventional PLS mode, the maximum transmittance is increased and then decreased as the retardation (d^{Δ}n) is increased. However, in the display panel according to the present exemplary embodiment, e.g., when the rubbing-angle is 45 degree, the degree at which the maximum transmittance is increased and then decreased as the retardation is increased may be relatively reduced.

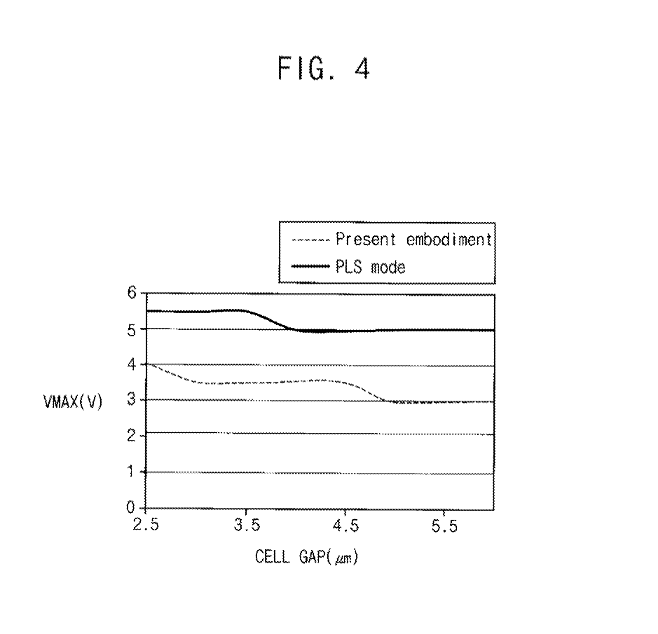

FIG. 4 is a graph illustrating voltage versus cell gap.

Referring to FIG. 4, an x-axis represents cell gaps, and a y-axis represents voltages for a maximum transmittance. The cell gap means a thickness of a liquid crystal layer (e.g., the liquid crystal layer 290 of FIG. 1). The transmittance means a transmittance of a display panel. The voltage means a voltage difference between a first electrode and a second electrode (e.g., the first and second electrodes EL1 and EL2, respectively, of FIG. 1). Thus, the y-axis shows the voltage difference (Vmax) between a first electrode and a second electrode when the display panel has a maximum transmittance.

In the display panel according to the present exemplary embodiment, the voltage difference Vmax, when the transmittance has a maximum value with respect to the cell gap, is illustrated in FIG. 4.

In a display panel using a conventional PLS mode, the voltage difference Vmax, when the transmittance has a maximum value with respect to the cell gap, is also illustrated in FIG. 4.

In the present exemplary embodiment and the conventional PLS mode display panel, a dielectric constant Δ∈ is −4, and a rubbing-angle is 7 degrees.

As illustrated in FIG. 4, the display panel according to the present exemplary embodiment has a relatively low driving voltage compared to the conventional PLS mode display panel.

Referring again to FIGS. 2 to 4, the display panel according to the present exemplary embodiment has a slight reduction in the maximum transmittance as the retardation (d^{Δ}n) is increased, e.g., when the rubbing angle is 45 degrees, compared to the conventional PLS mode display panel. The display panel according to the present exemplary embodiment has a relatively low driving voltage compared to the conventional PLS mode display panel.

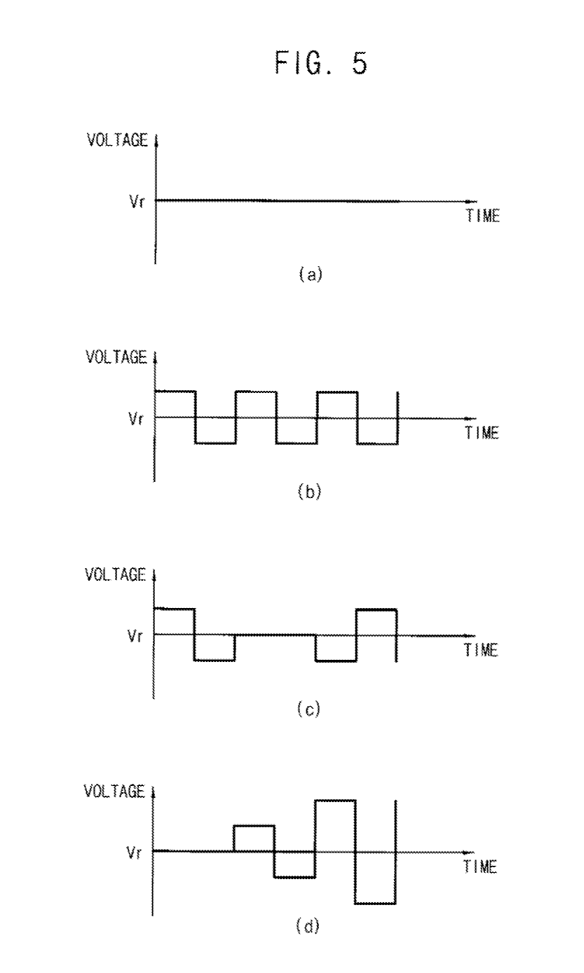

FIG. 5A to 5D are graphs respectively illustrating voltages applied to the third, second and first electrodes of FIG. 1 and an effective voltage.

Referring to FIGS. 1 and 5A, a third voltage is applied to the third electrode EL3. The third voltage is the same as a reference voltage Vr. For example, each of the third voltage and the reference voltage Vr is about 8 volts to about 9 volts.

Referring to FIGS. 1 and 5B, a second voltage alternating with respect to the reference voltage Vr is applied to the second electrode EL2. For example, the second voltage alternates from about +5 volts to about −5 volts with respect to the reference voltage Vr.

Referring to FIGS. 1 and 5C, a first voltage is applied to the first electrode EL1 to drive liquid crystal molecules. For example, the first voltage may be in a range of from about +8 volts or about +9 volts to about −8 volts or about −9 volts with respect to the reference voltage Vr to drive the liquid crystal molecules.

Referring to FIGS. 1 to 5D, the effective voltage is applied to the liquid crystal molecules of the liquid crystal layer 290 by the first to third voltages. The effective voltage may be determined by a voltage difference between the second electrode EL2 and the first electrode EL1.

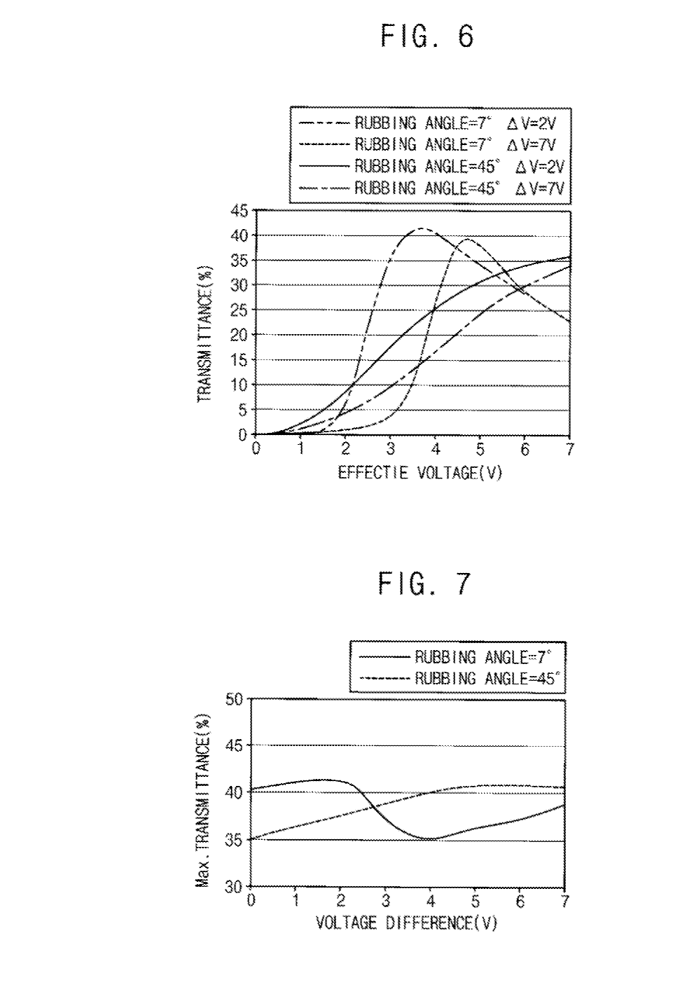

FIG. 6 is a graph illustrating transmittance versus voltage difference between a second electrode and a first second electrode of the display panel of FIG. 1 for rubbing-angles and voltage differences between a third electrode and the second electrode.

Referring to FIGS. 1 and 6, a graph shows changes in transmittance with respect to effective voltages which are voltage differences between the third electrode EL3 and the first electrode EL1, when a voltage difference ΔV between the third electrode EL3 and the second electrode EL2 is 2 volts, and the rubbing-angle (e.g., the rubbing-angle described above in connection with FIG. 2) is 7 degrees (RUBBING-ANGLE-7, ΔV=2).

A graph shows changes in the transmittance with respect to the effective voltages which are voltage differences between the third electrode EL3 and the first electrode EL1, when the voltage difference ΔV between the third electrode EL3 and the second electrode EL2 is 7 volts, and the rubbing-angle (e.g., the rubbing-angle described above in connection with FIG. 2) is 7 degrees (RUBBING-ANGLE=7, ΔV=7).

A graph shows changes in the transmittance with respect to the effective voltages which are voltage differences between the third electrode EL3 and the first electrode EL1, when the voltage difference ΔV between the third electrode EL3 and the second electrode EL2 is 2 volts, and the rubbing-angle (e.g., the rubbing-angle described above in connection with FIG. 2) is 45 degrees (RUBBING-ANGLE=45, ΔV=2).

A graph shows changes in the transmittance with respect to the effective voltages which are voltage differences between the third electrode EL3 and the first electrode EL1 when the voltage difference ΔV between the third electrode EL3 and the second electrode EL2 is 7 volts, and the rubbing-angle (e.g., the rubbing-angle described above in connection with FIG. 2) is 45 degrees (RUBBING-ANGLE-45, ΔV=7).

Constant voltages may be applied to the third electrode EL3 and the second electrode EL2, respectively, and a voltage to drive the liquid crystal molecules may be applied to the first electrode EL1. When the rubbing-angle is 45 degrees, a deviation between when the voltage difference ΔV is 2 volts and when the voltage difference is 7 volts is small compared to when the rubbing-angle is 7 degrees.

FIG. 7 is a graph illustrating maximum transmittance versus voltage difference between the third electrode and the second electrode of the display panel of FIG. 1 for rubbing-angles.

Referring to FIGS. 1 and 7, a graph shows maximum transmittances with respect to the voltage differences between the third electrode EL3 and the second electrode EL2 when a rubbing-angle (e.g., the rubbing-angle described above in connection with FIG. 2) is 7 degrees.

A graph shows maximum transmittances with respect to the voltage differences between the third electrode EL3 and the second electrode EL2 when a rubbing-angle (e.g., the rubbing-angle described above in connection with FIG. 2) is 45 degrees.

In light of the results of FIGS. 6 and 7, the maximum transmittance reaches a maximum value when the voltage difference is about 5 volts in a case where the rubbing-angle is 45 degrees. When the voltage difference alternates from about 2 volts to about 7 volts, a deviation between changes in transmittance is relatively small.

Thus, the method of driving a display panel described above in connection with FIG. 5 may be optimized when the rubbing-angle is 45 degrees.

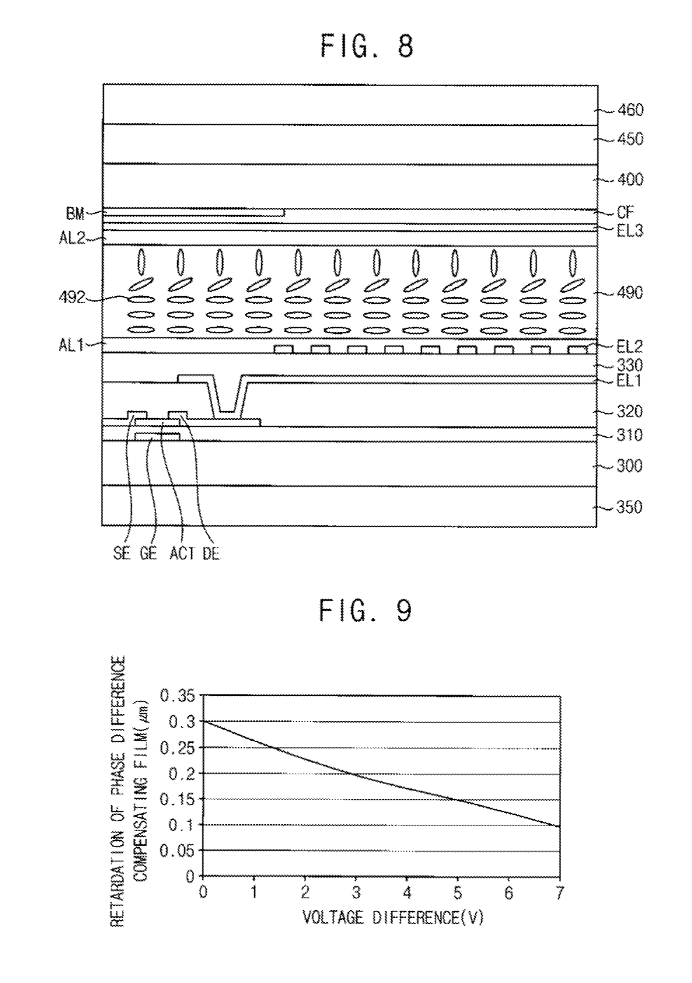

FIG. 8 is a cross-sectional view illustrating a display panel according to an exemplary embodiment of the invention.

Referring to FIG. 8, the display panel is the same or substantially the same as the display panel of FIG. 1, except that the display panel of FIG. 8 further includes a lower polarizer 350, and an upper polarizer 460.

The display panel includes an array substrate, an opposite substrate, and a liquid crystal layer 490 disposed between the array substrate and the opposite substrate. The array substrate includes a first substrate 300, a gate electrode GE, a first insulation layer 310, an active layer ACT, a data electrode DE, a source electrode SE, a second insulation layer 320, a first electrode EL1, a third insulation layer 330, a second electrode EL2, and a lower alignment layer AL1. The opposite substrate includes a second substrate 400, a black matrix BM, a color filter CF, a third electrode EL3, and an upper alignment layer AL2.

The first substrate 300 may be a transparent insulation substrate made of, e.g., glass and/or plastic.

The gate electrode GE is disposed on the first substrate 300, and electrically connected to a gate line. The gate electrode GE may include copper (Cu) and copper oxide (CuOx). The gate electrode GE may include gallium doped zinc oxide (GZO), indium doped zinc oxide (GZO) and/or manganese-copper alloy (CuMn).

The first insulation layer 310 is disposed on the gate electrode GE and electrically insulates the gate electrode GE from other elements. The first insulation layer 310 may include silicon oxide (SiOx) and silicon nitride (SiNx).

The active layer ACT is disposed on the first insulation layer 310. The active layer ACT overlaps the gate electrode GE.

The active layer ACT may include a semiconductor layer including amorphous silicon (a-Si:H) and an ohmic contact layer including n+ amorphous silicon (n+ a-Si:H). The active layer ACT may include an oxide semiconductor. The oxide semiconductor may include an amorphous oxide including at least one of indium (In), zinc (Zn), gallium (Ga), tin (Sn) and hafnium (Hf). The oxide semiconductor may include an amorphous oxide including indium (In), zinc (Zn) and gallium (Ga), or an amorphous oxide including indium (In), zinc (Zn) and hafnium (Hf). The oxide semiconductor may include an oxide, such as indium zinc oxide (InZnO), indium gallium oxide (InGaO), indium tin oxide (InSnO), zinc tin oxide (ZnSnO), gallium tin oxide (GaSnO) and gallium zinc oxide (GaZnO). For example, the active layer ACT may include indium gallium zinc oxide (IGZO).

The source electrode SE is disposed on the active layer ACT, and electrically connected to a data line that crosses the gate line. The source electrode SE partially overlaps the gate electrode GE. The source electrode SE may include copper (Cu) and copper oxide (CuOx). The source electrode SE may include gallium doped zinc oxide (GZO), indium doped zinc oxide (GZO) and/or manganese-copper alloy (CuMn).

The drain electrode DE is disposed on the active layer ACT. The drain electrode DE partially overlaps the gate electrode GE, and is spaced apart from the source electrode SE. The drain electrode DE may include copper (Cu) and copper oxide (CuOx). The drain electrode DE may include gallium doped zinc oxide (GZO), indium doped zinc oxide (GZO) and/or manganese-copper alloy (CuMn). Boundaries of the active layer ACT may coincide with boundaries of the source electrode SE and the drain electrode DE. The active layer ACT, the drain electrode DE, the gate electrode GE and the source electrode SE and the source electrode SE form a thin film transistor.

The second insulation layer 320 is disposed on the first insulation layer 310 on which the source electrode SE and the drain electrode DE are disposed. The second insulation layer 320 electrically insulates the source electrode SE, the active layer ACT and the drain electrode DE from other elements. The second insulation layer 320 may include silicon oxide (SiOx) and silicon nitride (SiNx).

The first electrode EL1 is disposed on the second insulation layer 320, and corresponds to a pixel area where an image is displayed. The first electrode EL1 is electrically connected to the drain electrode DE through a contact hole which is formed on the second insulation layer 320 and which partially exposes the drain electrode DE. The first electrode EL1 may include a transparent conductive material, such as indium tin oxide (ITO), or indium zinc oxide (IZO). The first electrode EL1 may include titanium (Ti) and/or molybdenum titanium (MoTi).

The third insulation layer 330 is disposed on the first electrode EL1. The third insulation layer 330 electrically insulates the first electrode EL1 from other elements. The third insulation layer 330 may include silicon oxide (SiOx) and silicon nitride (SiNx).

The second electrode EL2 is disposed on the third insulation layer 330, and corresponds to the pixel area. The second electrode EL2 has a slit pattern.

The second electrode EL2 may include a transparent conductive material, such as indium tin oxide (ITO), or indium zinc oxide (IZO). The second electrode EL2 may include titanium (Ti) and/or molybdenum titanium (MoTi).

The first alignment layer AL1 is disposed on the second electrode EL2 and the third insulation layer 330. Liquid crystal directors 492 disposed in a lower portion of the liquid crystal layer 490 may be aligned in a horizontal direction by the first alignment layer AL1. For example, the first alignment layer AL1 may be rubbed to align liquid crystal molecules included in the lower portion of the liquid crystal layer 490 along the horizontal direction.

The lower polarizer 350 is disposed under the first substrate 300. A transmission axis of the lower polarizer 350 may be substantially parallel with the rubbing-angle (e.g., the rubbing-angle described above in connection with FIG. 2). The transmission axis of the lower polarizer 350 may be substantially perpendicular to the rubbing-angle.

The second substrate 400 may be a transparent insulation substrate made of, e.g., glass and/or plastic.

The black matrix BM is disposed under the second substrate 400. The black matrix BM corresponds to an area other than the pixel area, and blocks light. The black matrix BM overlaps the thin film transistor, the data line and the gate line.

The color filter CF is disposed under the black matrix BM and the second substrate 400. Light passing through the color filter CF from the liquid crystal layer 490 has a color. The color filter CF may include a red color filter, a green color filter or a blue color filter. The color filter CF corresponds to the pixel area. Color filters adjacent to each other may have different colors, respectively. The color filter CF may overlap an adjacent color filter CF at a boundary of the pixel area, or the color filter CF may be spaced apart from the adjacent color filter CF at the boundary of the pixel area.

The third electrode EL3 is disposed under the color filter CF. The third electrode EL3 may include a transparent conductive material, such as indium tin oxide (ITO), or indium zinc oxide (IZO). The third electrode EL3 may include titanium (Ti) and/or molybdenum titanium (MoTi).

The second alignment layer AL2 is disposed under the third electrode EL3. Liquid crystal directors 492 disposed in an upper portion of the liquid crystal layer 490 may be aligned along a vertical direction by the second alignment layer AL2. For example, the second alignment layer AL2 need not have a rubbing axis to align liquid crystal molecules in the upper portion of the liquid crystal layer 490 along the vertical direction.

The liquid crystal layer 490 is disposed between the array substrate and the opposite substrate. The liquid crystal layer 490 includes liquid crystal molecules having optical anisotropy. The liquid crystal molecules are driven by an electric field, and an image is displayed by passing or blocking light through the liquid crystal layer 490.

The liquid crystal directors 492 represent directions of the liquid crystal molecules. According to the rubbing axis of the first and second alignment layers AL1 and AL2 contacting the liquid crystal layer 490, directions of the liquid crystal directors 492 adjacent to the first and second alignment layers AL1 and AL2 may be determined.

The liquid crystal directors 492 in the lower portion of the liquid crystal layer 490 are substantially parallel with the first and second substrates 300 and 400. The liquid crystal directors 492 in the upper portion of the liquid crystal layer 490 are substantially perpendicular to the first and second substrates 300 and 400.

The phase-difference compensating film 450 is disposed on the second substrate 400. The phase-difference compensating film 450 may have a retardation δ (δ=d^{Δ}n; d means cell gap, n means refractive index) to compensate for a phase retardation of the liquid crystal layer.

The phase-difference compensating film 450 includes a plurality of discotic liquid crystal molecules arranged in a predetermined form to compensate for the phase retardation.

The upper polarizer 460 is disposed on the phase-difference compensating film 450. A transmission axis of the upper polarizer 460 is substantially perpendicular to a transmission axis of the lower polarizer 350. Thus, the transmission axis of the upper polarizer 460 may be substantially perpendicular to the rubbing-angle (e.g., the rubbing-angle described above in connection with FIG. 2). The transmission axis of the upper polarizer 460 may be substantially parallel with to the rubbing-angle.

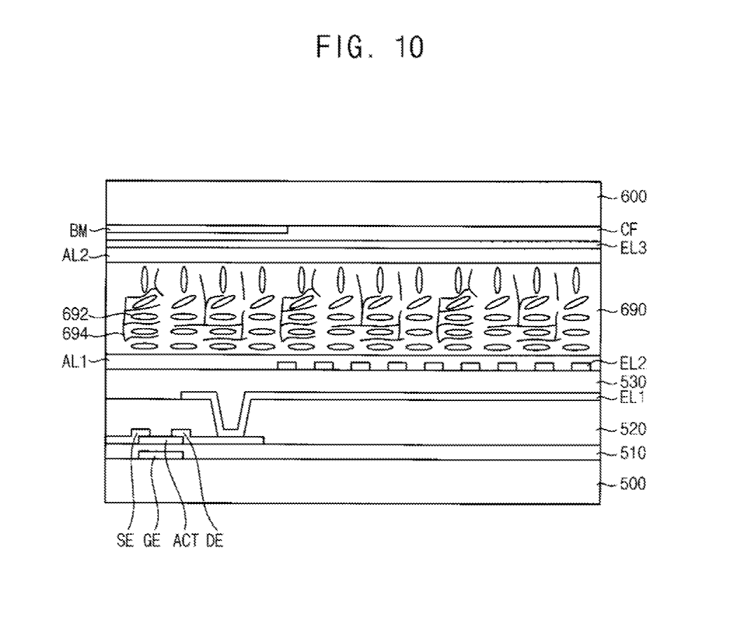

FIG. 9 is a graph illustrating the retardation of a phase-difference compensating film transmittance versus voltage difference between the third electrode and the second electrode of the display panel of FIG. 1.

Referring to FIGS. 1 and 9, a retardation value of a phase-difference compensating film decreases as a voltage difference between the third electrode EL3 and the second electrode EL2 increases.

The retardation value may be adjusted by adjusting the voltage difference between the third electrode EL3 and the second electrode EL2. Thus, a conventional phase-difference compensating film may be used in the display panel by adjusting the voltage difference between the third electrode EL3 and the second electrode EL2.

FIG. 10 is a cross-sectional view illustrating a display panel according to an exemplary embodiment of the invention.

Referring to FIG. 10, the display panel is substantially the same as the display panel of FIG. 1 except that a liquid crystal layer 690 includes a reactive monomer (694).

The display panel includes an array substrate, an opposite substrate, and a liquid crystal layer 690 disposed between the array substrate and the opposite substrate. The array substrate includes a first substrate 500, a gate electrode GE, a first insulation layer 510, an active layer ACT, a data electrode DE, a source electrode SE, a second insulation layer 520, a first electrode EL1, a third insulation layer 530, a second electrode EL2, and a lower alignment layer AL1. The opposite substrate includes a second substrate 600, a black matrix BM, a color filter CF, a third electrode EL3, and an upper alignment layer AL2.

The first substrate 500 may be a transparent insulation substrate made of, e.g., glass and/or plastic.

The gate electrode GE is disposed on the first substrate 500, and electrically connected to a gate line. The gate electrode GE may includes may include copper (Cu) and copper oxide (CuOx). The gate electrode GE may include gallium doped zinc oxide (GZO), indium doped zinc oxide (GZO) and/or manganese-copper alloy (CuMn).

The first insulation layer 510 is disposed on the gate electrode GE to electrically insulate the gate electrode GE from other elements. The first insulation layer 510 may include silicon oxide (SiOx) and silicon nitride (SiNx).

The active layer ACT is disposed on the first insulation layer 510. The active layer ACT overlaps the gate electrode GE.

The active layer ACT may include a semiconductor layer including amorphous silicon (a-Si:H) and an ohmic contact layer including n+ amorphous silicon (n+ a-Si:H). The active layer ACT may include an oxide semiconductor. The oxide semiconductor may include an amorphous oxide including at least one of indium (In), zinc (Zn), gallium (Ga), tin (Sn) and hafnium (Hf). The oxide semiconductor may include an amorphous oxide including indium (In), zinc (Zn) and gallium (Ga), or an amorphous oxide including indium (In), zinc (Zn) and hafnium (Hf). The oxide semiconductor may include an oxide, such as indium zinc oxide (InZnO), indium gallium oxide (InGaO), indium tin oxide (InSnO), zinc tin oxide (ZnSnO), gallium tin oxide (GaSnO) and gallium zinc oxide (GaSnO). For example, the active layer ACT may include indium gallium zinc oxide (IGZO).

The source electrode SE is disposed on the active layer ACT, and electrically connected to a data line crossing the gate line. The source electrode SE partially overlaps the gate electrode GE. The source electrode SE may includes may include copper (Cu) and copper oxide (CuOx). The source electrode SE may include gallium doped zinc oxide (GZO), indium doped zinc oxide (GZO) and/or manganese-copper alloy (CuMn).

The drain electrode DE is disposed on the active layer ACT. The drain electrode DE partially overlaps the gate electrode GE, and is spaced apart from the source electrode SE. The drain electrode DE may include copper (Cu) and copper oxide (CuOx). The drain electrode DE may include gallium doped zinc oxide (GZO), indium doped zinc oxide (GZO) and/or manganese-copper alloy (CuMn). Boundaries of the active layer ACT may coincide with boundaries of the source electrode SE and the drain electrode DE. The active layer ACT, the drain electrode DE, the gate electrode GE, the source electrode SE and the source electrode SE form a thin film transistor.

The second insulation layer 520 is disposed on the first insulation layer 510 on which the source electrode SE and the drain electrode DE are disposed. The second insulation layer 520 electrically insulates the source electrode SE, the active layer ACT and the drain electrode DE from other elements. The second insulation layer 520 may include silicon oxide (SiOx) and silicon nitride (SiNx).

The first electrode EL1 is disposed on the second insulation layer 520, and corresponds to a pixel area where an image is displayed. The first electrode EL1 is electrically connected to the drain electrode DE through a contact hole which is formed on the second insulation layer 520 and which partially exposes the drain electrode DE. The first electrode EL1 may include a transparent conductive material, such as indium tin oxide (ITO), or indium zinc oxide (IZO). The first electrode EL1 may include titanium (Ti) and/or molybdenum titanium (MoTi).

The third insulation layer 530 is disposed on the first electrode EL1. The third insulation layer 530 electrically insulates the first electrode EL1 from other elements. The third insulation layer 530 may include silicon oxide (SiOx) and silicon nitride (SiNx).

The second electrode EL2 is disposed on the third insulation layer 530, and corresponds to the pixel area. The second electrode EL2 has a slit pattern.

The second electrode EL2 may include a transparent conductive material, such as indium tin oxide (ITO), or indium zinc oxide (IZO). The second electrode EL2 may include titanium (Ti) and/or molybdenum titanium (Mori).

The first alignment layer AL1 is disposed on the second electrode EL2 and the third insulation layer 530. Liquid crystal directors 692 disposed in a lower portion of the liquid crystal layer 690 may be aligned in a horizontal direction by the first alignment layer AL1. For example, the first alignment layer AL1 may be rubbed to align liquid crystal molecules in the lower portion of the liquid crystal layer 690 along the horizontal direction.

The second substrate 600 may be a transparent insulation substrate made of, e.g., glass and/or plastic.

The black matrix BM is disposed under the second substrate 600. The black matrix BM corresponds to an area other than the pixel area, and blocks light. The black matrix BM overlaps the thin film transistor, the data line and the gate line.

The color filter CF is disposed under the black matrix BM and the second substrate 600. Light passing through the color filter CF from the liquid crystal layer 690 has a color. The color filter CF may include a red color filter, a green color filter, or blue color filter. The color filter CF corresponds to the pixel area. Color filters adjacent to each other may have different colors, respectively. The color filter CF may overlap an adjacent color filter CF at a boundary of the pixel area, or the color filter CF may be spaced apart from the adjacent color filter CF at the boundary of the pixel area.

The third electrode EL3 is disposed under the color filter CF. The third electrode EL3 may include a transparent conductive material, such as indium tin oxide (ITO), or indium zinc oxide (IZO). The third electrode EL3 may include titanium (Ti) and/or molybdenum titanium (MoTi).

The second alignment layer AL2 is disposed under the third electrode EL3. The second alignment layer AL2. Liquid crystal directors 692 disposed in an upper portion of the liquid crystal layer 690 may be aligned in a vertical direction by the second alignment layer AL2. For example, the second alignment layer AL2 need not have a rubbing axis to align liquid crystal molecules in the upper portion of the liquid crystal layer 690 along the vertical direction.

The liquid crystal layer 690 is disposed between the array substrate and the opposite substrate. The liquid crystal layer 690 includes liquid crystal molecules having optical anisotropy. The liquid crystal molecules are driven by an electric field, and an image is displayed by passing or blocking light through the liquid crystal layer 690.

The liquid crystal directors 692 represent directions of the liquid crystal molecules. According to the rubbing axis of the first and second alignment layers AL1 and AL2 contacting the liquid crystal layer 690, directions of the liquid crystal director 692 adjacent to the first and second alignment layers AL1 and AL2 may be determined.

The liquid crystal directors 692 in the lower portion of the liquid crystal layer 690 are substantially parallel with the first and second substrates 500 and 600. The liquid crystal directors 692 in the upper portion of the liquid crystal layer 690 are substantially perpendicular to the first and second substrates 500 and 600.

The liquid crystal layer 690 includes a reactive monomer 694. The reactive monomer 694 may be, e.g., an acrylic photoreactive monomer. A content of the reactive monomer 694 in the liquid crystal layer 690 may be about 0.2 wt % to about 20 wt %.

The reactive monomer 694 may be hardened by photoreaction to thus form a polymer network. Thus, off-time characteristics of the display panel may be improved. For example, an off-time which is a time taken for liquid crystal molecules to return to an original position after a voltage applied to the liquid crystal molecules is removed, may be reduced. When a voltage applied to the liquid crystal molecules is relatively high, on-time characteristics of the display panel may be deteriorated due to the polymer network. For example, when a relatively high voltage is applied to the liquid crystal molecules, an on-time which is a time taken for liquid crystal molecules to react to a voltage applied to the liquid crystal molecules, may be increased by the polymer network. However, the display panel according to an exemplary embodiment is driven at a relatively low voltage, and thus, although the content of the reactive monomer 694 in the liquid crystal layer 690 is about 0.2 wt % to about 20 wt %, the off-time characteristics may be improved without deteriorating the on-time characteristics.

The reactive monomer 694 may include two or more or three or more polymerases.

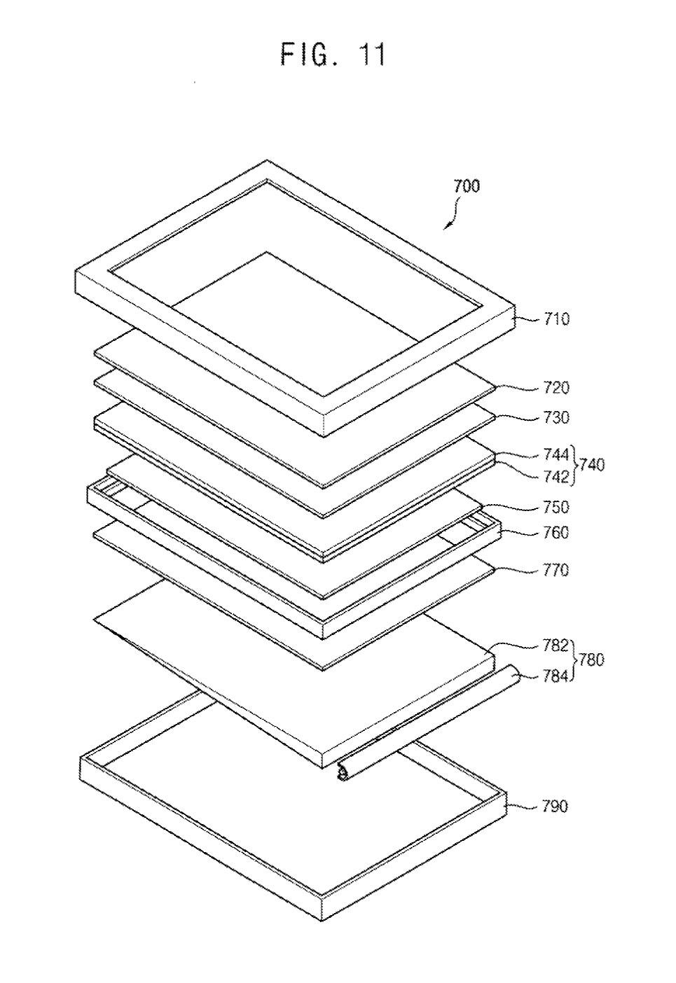

FIG. 11 is an exploded perspective view illustrating a display panel according to an exemplary embodiment of the invention.

Referring to FIG. 11, the display apparatus includes a top chassis 710, an upper polarizer 720, a phase-difference compensating film 730, a display panel 740, a lower polarizer 750, a mold frame 760, an optical element 770, a backlight assembly 780 and a bottom chassis 790.

The top chassis 710 and the bottom chassis 790 receive the upper polarizer 720, the phase-difference compensating film 730, the display panel 740, the lower polarizer 750, the mold frame 760, the optical element 770, and the backlight assembly 780.

The mold frame 760 receives the upper polarizer 720, the phase-difference compensating film 730, the display panel 740, the lower polarizer 750, and the optical element 770.

The display panel 740 includes an array substrate 742, an opposite substrate 744, and a liquid crystal layer (not shown) disposed between the array substrate 742 and the opposite substrate 744. The display panel 740 is substantially the same as the display panel shown in FIG. 1.

The phase-difference compensating film 730 is disposed on the opposite substrate 744. The phase-difference compensating film 730 may have a retardation δ to compensate for a phase retardation (δ=d^{Δ}n; d means cell gap, n means refractive index) of the liquid crystal layer. The phase-difference compensating film 730 may include a plurality of discotic liquid crystal molecules arranged in a predetermined form to compensate for the phase retardation.

The upper polarizer 720 is disposed on the phase-difference compensating film 730. A transmission axis of the upper polarizer 720 is substantially perpendicular to a transmission axis of the lower polarizer 750. Thus, the transmission axis of the upper polarizer 720 may be substantially perpendicular to a rubbing-angle (e.g., the rubbing-angle described above in connection with FIG. 2). The transmission axis of the upper polarizer 460 may be substantially parallel with to the rubbing-angle.

The lower polarizer 750 is disposed under the array substrate 742. A transmission axis of the lower polarizer 750 may be substantially parallel with the rubbing-angle (e.g., the rubbing-angle described above in connection with FIG. 2). The transmission axis of the lower polarizer 750 may be substantially perpendicular to the rubbing-angle.

The optical element 770 is disposed under the display panel 740. The optical element 770 equalizes the brightness of light emitted from the backlight assembly 780. The optical element 770 may include one or more optical sheets. For example, the optical element 770 may include a protection sheet, a prism sheet, and a diffusion sheet. However, the embodiments of the present invention are not limited thereto, and the optical element 770 may include various types of more sheets.

The backlight assembly 780 is disposed under the optical element 770. The backlight assembly 780 generates light and supplies the light to the display panel 740. The backlight assembly 780 includes a light guiding plate 782 and a light source part 784. The light source part 784 generates light, and supplies the light to the light guiding plate 782. The light guiding plate 782 is disposed adjacent to the light source part 784, and directs the generated light toward the display panel 740, e.g., to function as a surface light source.

According to the exemplary embodiments of the present invention, the display panel includes the second electrode and the third electrode. A voltage difference between the second electrode and the third electrode may be adjusted to make a conventional phase-difference compensating film suitable for the display panel.

In addition, the rubbing-angle may be about 45 degrees, and thus, the response speed and transmittance of the display panel may be increased.

In addition, the display panel may be driven at a relative low voltage, and thus, off-time characteristic of the display panel may be improved without deteriorating on-time characteristics of the display panel even though the liquid crystal layer of the display panel includes a reactive monomer.

The foregoing is illustrative of the embodiments of the invention and is not to be construed as limiting thereof. Although a few exemplary embodiments of the invention have been described, those skilled in the art will readily appreciate that many modifications are possible in the exemplary embodiments of the invention. Accordingly, all such modifications are intended to be included within the scope of the embodiments of the invention as defined in the claims.

What is claimed is:

1. A display panel comprising:
an array substrate comprising,
a first substrate,
a first electrode disposed on the first substrate, and
a second electrode disposed on the first electrode, the second electrode insulated from the first electrode and having a slit pattern;
an opposite substrate facing the array substrate, the opposite substrate comprising,
a second substrate, and
a third electrode disposed on the second substrate, wherein a voltage applied to the third electrode is different from a voltage applied to the second electrode; and
a liquid crystal layer disposed between the array substrate and the opposite substrate, and comprising a reactive monomer.

2. The display panel of claim 1, wherein a reference voltage is applied to the third electrode, and a voltage alternating with respect to the reference voltage is applied to the second electrode.

3. The display panel of claim 2, further comprising a lower alignment layer disposed under the liquid crystal layer, wherein the lower alignment layer is configured to align liquid crystal directors in a lower portion of the liquid crystal layer along a horizontal direction of the display panel.

4. The display panel of claim 3, wherein the lower alignment layer has a rubbing axis inclined at 45 degrees with respect to a longitudinal direction of the slit pattern of the second electrode.

5. The display panel of claim 4, further comprising an upper alignment layer disposed on the liquid crystal, wherein the upper alignment layer is configured to align liquid crystal directors in an upper portion of the liquid crystal layer along a vertical direction of the display panel.

6. The display panel of claim 2, wherein the voltage alternates in a range of about +5 volts to about −5 volts with respect to the reference voltage.

7. The display panel of claim 1, further comprising a phase-difference compensating film disposed on the opposite substrate, wherein the phase-difference compensating film is configured to compensate for a retardation (d^{Δ}n) of the liquid crystal layer, wherein d means a cell gap, and n means a refractive index.

8. The display panel of claim 7, wherein a retardation of the phase-difference compensating film is about 0.01 μm to about 0.8 μm.

9. The display panel of claim 1, wherein the reactive monomer comprises an acrylic photoreactive monomer.

10. The display panel of claim 1, wherein a concentration of the reactive monomer in the liquid crystal layer is about 0.2 wt % to about 20 wt %.

11. A display apparatus comprising:
a display panel configured to display an image;
a backlight assembly disposed under the display panel and configured to supply light to the display panel; and
a receiving container receiving the display panel and the backlight assembly, wherein the display panel comprising:
an array substrate comprising,
a first substrate,
a first electrode disposed on the first substrate, and
a second electrode disposed on the first electrode, the second electrode insulated from the first electrode and having a slit pattern;
an opposite substrate facing the array substrate, the opposite substrate comprising,
a second substrate, and
a third electrode disposed on the second substrate, wherein a voltage applied to the third electrode is different from a voltage applied to the second electrode; and
a liquid crystal layer disposed between the array substrate and the opposite substrate and comprising a reactive monomer.

12. The display apparatus of claim 11, wherein a reference voltage is applied to the third electrode, and a voltage alternating with respect to the reference voltage is applied to the second electrode.

13. The display apparatus of claim 2, wherein the display panel further comprising a lower alignment layer disposed under the liquid crystal layer, wherein the lower alignment layer is configured to align liquid crystal directors in a lower portion of the liquid crystal layer along a horizontal direction of the display panel.

14. The display apparatus of claim 13, wherein the lower alignment layer has a rubbing axis inclined at 45 degrees with respect to a longitudinal direction of the slit pattern of the second electrode.

15. The display apparatus of claim 14, wherein the display panel further comprising an upper alignment layer disposed on the liquid crystal, wherein the upper alignment layer is configured to align liquid crystal directors in an upper portion of the liquid crystal layer along a vertical direction of the display panel.

16. The display apparatus of claim 12, wherein the voltage alternates in a range of about +5 volts to about −5 volts with respect to the reference voltage.

17. The display apparatus of claim 11, further comprising a phase-difference compensating film disposed on the opposite substrate and configured to compensate for a retardation (d^{Δ}n) of the liquid crystal layer, wherein d means a cell gap, and n means a refractive index.

18. The display apparatus of claim 17, wherein a retardation of the phase-difference compensating film is about 0.01 μm to about 0.8 μm.

19. The display apparatus of claim 11, wherein the reactive monomer comprises an acrylic photoreactive monomer.

20. The display apparatus of claim 19, wherein a concentration of the reactive monomer in the liquid crystal layer is about 0.2 wt % to about 20 wt %.

21. A display panel comprising:
a first substrate having a first electrode;
a second substrate opposite to the first substrate, the second substrate having a second electrode, a third electrode, and a switching element connected to the third electrode; and
a liquid crystal layer between the first substrate and the second substrate, wherein the first electrode is applied with a constant voltage, and the second electrode is applied with an alternating voltage.
